(19) United States
(12) Patent Application Publication
(10) Pub. No.: US 2019/0266498 A1
(43) Pub. Date: Aug. 29, 2019

(54) BEHAVIORAL MODELS FOR VEHICLES

(71) Applicant: Cisco Technology, Inc., San Jose, CA (US)

(72) Inventors: David A. Maluf, Mountain View, CA (US); Shesha Bhushan Sreenivasamurthy, Fremont, CA (US)

(21) Appl. No.: 15/907,584

(22) Filed: Feb. 28, 2018

(51) Int. Cl. G06N 5/04; G06N 99/00; G07C 5/00

(52) U.S. Cl. CPC G06N 5/04; H04L 12/40013; G07C 5/008; G06N 99/005

(57) ABSTRACT

In one embodiment, a processor of a vehicle receives a plurality of variables indicative of physical characteristics of the vehicle. The processor uses a machine learning-based model to predict physical states of the vehicle from the plurality of variables indicative of physical characteristics of the vehicle. The model predicts a current physical state of the vehicle from at least two or more prior physical states of the vehicle, and is based on a physical relationship between the physical characteristics. The processor sends synthetic data indicative of the predicted current physical state of the vehicle for use by a receiver application. The processor provides an update to the receiver based on a comparison between the predicted current physical state of the vehicle and the plurality of received variables.

### TECHNICAL FIELD

The present disclosure relates generally to computer networks, and, more particularly, to behavioral models for vehicles.

### BACKGROUND

In recent years, the amount and type of data collected by cloud-based services and data centers from edge devices has been increasing significantly. This is particularly true in the case of edge devices, such as passenger and commercial vehicles. For example, a vehicle of the future may produce multiple terabytes (TBs) of data per day. However, many existing gateways do not support the size requirements of this additional data. Notably, a typical mobile gateway operates over a Long-Term Evolution (LTE) cellular connection at the lower Megabits range speed. For example, consider a Lidar sensor in a vehicle that produces over 2 TB of data per day. In such a case, it would be impractical to transmit this data over an existing Gigabit switch. With the ongoing efforts to develop smart cars and autonomous vehicles, as well as to outfit vehicles with more and more sensors, these data requirements will only continue to increase, placing an increasing burden on the communication infrastructure.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication system;

FIG. 2 illustrates an example network device/node;

FIG. 3 illustrates an example architecture for vehicle telematics with super resolution;

FIGS. 4A-4B illustrate an example of a vehicle providing data to a receiver application;

FIG. 5 illustrates an example of data conversion in a vehicle; and

FIG. 6 illustrates an example simplified procedure for modeling vehicle behavior.

### DESCRIPTION OF EXAMPLE EMBODIMENTS

### Overview

According to one or more embodiments of the disclosure, a processor of a vehicle receives a plurality of variables indicative of physical characteristics of the vehicle. The processor uses a machine learning-based model to predict physical states of the vehicle from the plurality of variables indicative of physical characteristics of the vehicle. The model predicts a current physical state of the vehicle from at least two or more prior physical states of the vehicle, and is based on a physical relationship between the physical characteristics. The processor sends synthetic data indicative of the predicted current physical state of the vehicle for use by a receiver application. The processor provides an update to the receiver based on a comparison between the predicted current physical state of the vehicle and the plurality of received variables.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or power-line communication (PLC) networks. That is, in addition to one or more sensors, each sensor device (node) in a sensor network may generally be equipped with a radio transceiver or other communication port, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

Networks may also be, or may include, an “Internet of Things” or “IoT” network.

Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

Serial networks are another type of network, different from an IP network, typically forming a localized network in a given environment, such as for automotive or vehicular networks, industrial networks, entertainment system networks, and so on. For example, those skilled in the art will be familiar with the on-board diagnostics (OBD) protocol (a serial network which supports a vehicle's self-diagnostic and reporting capability, including the upgraded “OBD II” protocol), the Controller Area Network (CAN) bus (or CANBUS) protocol (a message-based protocol to allow microcontrollers and devices to communicate with each other in applications without a host computer), and the MODBUS protocol (a serial communications protocol for use with programmable logic controllers, such as for remote terminal units (RTUs) in supervisory control and data acquisition (SCADA) systems). Unlike an IP-based network, which uses a shared and open addressing scheme, a serial communication network generally is based on localized and proprietary communication standards, where commands or data are transmitted based on localized device identifiers, such as parameter identifiers (PIDs), localized station addresses, and so on.

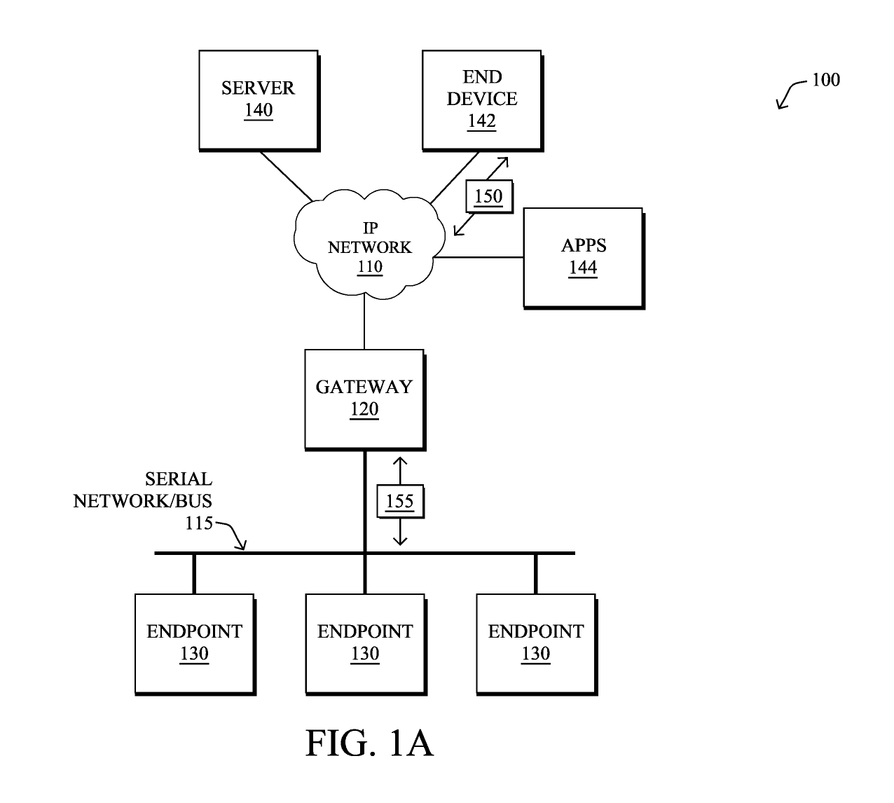

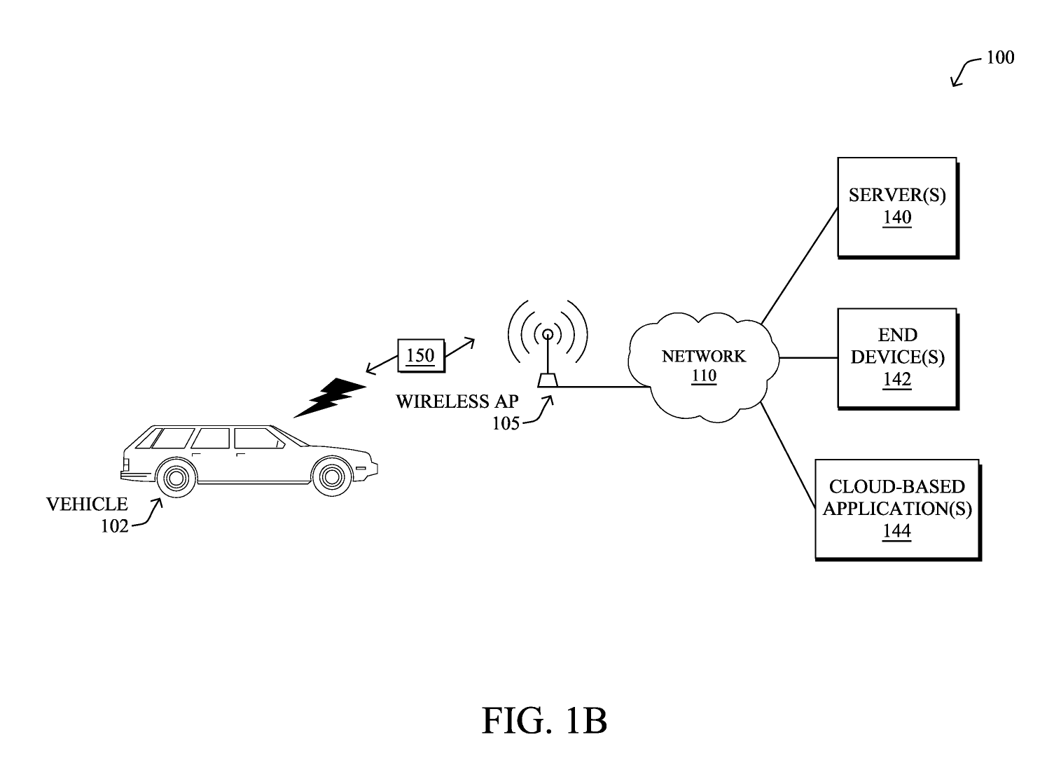

FIG. 1A illustrates an example communication system 100 illustratively comprising an Internet Protocol (IP) network 110 and a serial network/bus 115, along with a gateway (or other network device) 120 interconnecting the two networks, as described in greater detail below. Serial network 115, in particular, illustratively comprises one or more endpoints 130 (e.g., a set of one or more controlled devices, sensors, actuators, controllers, processors, and so on), such as part of a vehicular network, an industrial network, etc. The endpoints may be interconnected by various methods of serial communication. For instance, the serial network/bus 115 may allow the endpoints 130 to communicate serial data 155 (e.g., commands, sensor data, etc.) using predefined serial network communication protocols (e.g., OBD, CANBUS, MODBUS, etc.). In this context, a serial network protocol consists of a set of rules defining how the endpoints interact within the serial network 115.

IP network 110, on the other hand, illustratively comprises links interconnecting one or more devices through a network of routers or switches. For example, a set of one or more servers (or controllers) 140, one or more end devices (e.g., user devices, workstations, etc.) 142, and one or more other application devices 144 may be interconnected with the IP network 110. The devices, generally, may be interconnected by various methods of IP-based communication. For instance, the links may be wired links or shared media (e.g., wireless links, PLC links, etc.) where certain devices may be in communication with other devices, e.g., based on distance, signal strength, current operational status, location, etc. IP data packets 150 (e.g., traffic and/or messages sent between the devices/nodes) may be exchanged among the nodes/devices of the IP network 110 using predefined IP network communication protocols such as the transmission control protocol (TCP), TCP/IP, user datagram protocol (UDP), or other protocols where appropriate. In this context, an IP network protocol consists of a set of rules defining how the nodes interact with each other over the IP network 110.

As described below, the gateway device 120 illustratively bridges both the IP network 110 and serial network 115, and as such may be considered to be a part of either or each network, accordingly. Further, those skilled in the art will understand that any number of nodes, devices, links, endpoints, etc. may be used in the computer system 100, and that the view shown herein is for simplicity. Also, those skilled in the art will further understand that while the system is shown in a certain orientation, system 100 is merely an example illustration that is not meant to limit the disclosure.

FIG. 1B illustrates one potential implementation of communication system 100, according to various embodiments. As shown, assume that system 100 includes a vehicle 102 in which serial network/bus 115 and gateway 120 are located. For example, many passenger vehicles now include a CANBus-based serial network that connects any number of endpoint sensors and/or actuators (endpoints 130). To connect the serial network 115 of vehicle 102 to IP network 110, gateway 120 resident on vehicle 102 may communicate remotely with a wireless access point (AP) 105. For example, vehicle 102 may be in remote communication with a cellular transceiver, Wi-Fi hotspot, or the like, to connect vehicle 102 with network 110. In further embodiments, vehicle 102 may instead be in communication with network 110 via a wired connection. For example, vehicle 102 may be connected to network 110 during charging (e.g., in the case an electric or hybrid electric vehicle), storage, repair, or the like.

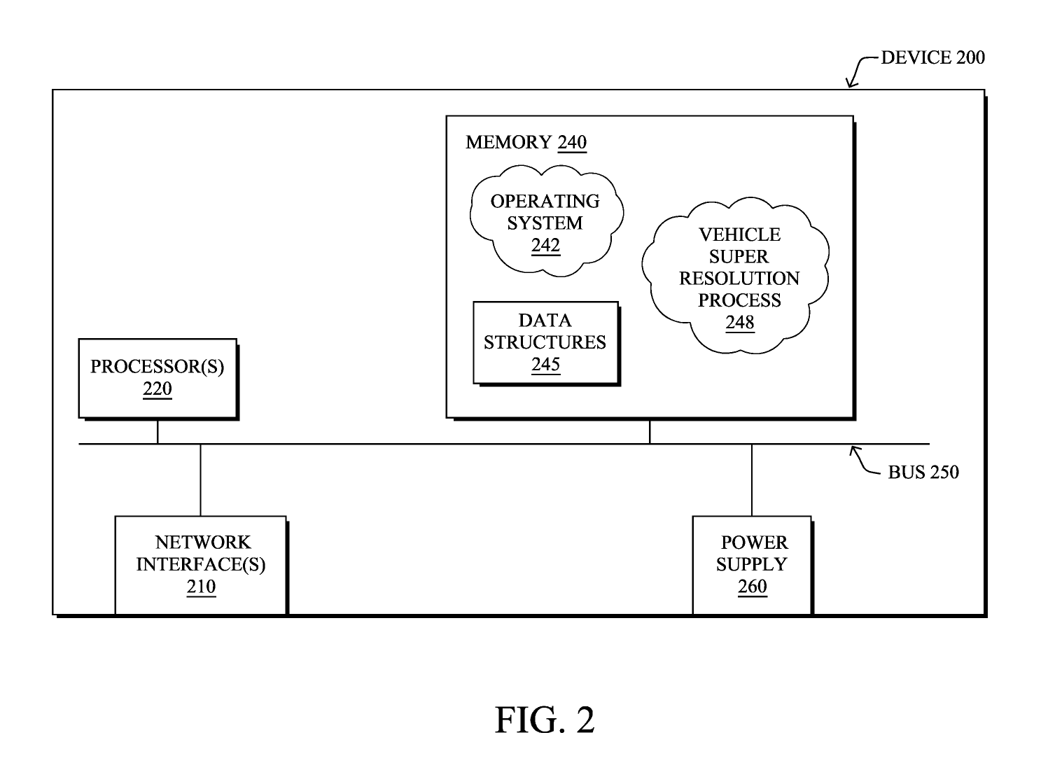

FIG. 2 is a schematic block diagram of an example node/device 200 that may be used with one or more embodiments described herein, e.g., as any of the nodes/devices shown in FIG. 1 above, particularly as the gateway device 120 as described herein. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the IP network 110 and/or serial network 115. The network interfaces 210 may be configured to transmit and/or receive data using a variety of different IP communication protocols, such as TCP/IP, UDP, etc. Note that the device 200 may have multiple different types of IP network connections 210, e.g., wireless and wired/physical connections, and that the view herein is merely for illustration. Also, while the IP network interface 210 is shown separately from power supply 260, for PLC the network interface 210 may communicate through the power supply 260, or may be an integral component of the power supply. In some specific configurations the PLC signal may be coupled to the power line feeding into the power supply.

In further embodiments, network interface(s) 210 may also include the other hand, include the mechanical, electrical, and signaling circuitry for communicating data over links coupled to the serial network 115. Notably, one or more of network interface(s) 210 may be configured to transmit and/or receive data using a variety of different serial communication protocols, such as OBD, CANBUS, MODBUS, etc., on any range of serial interfaces such as legacy universal asynchronous receiver/transmitter (UART) serial interfaces and modern serial interfaces like universal serial bus (USB).

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes / services may comprise an illustrative vehicle super resolution process 248, as described herein. Note that while process 248 is shown in centralized memory 240 alternative embodiments provide for the process to be specifically operated within the network interface(s) 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Many serial network endpoints, such as sensors and actuators found in vehicular or industrial systems, are specifically tailored to function based on a proprietary serial communication protocol. Typically, such endpoints are also not natively enabled for IP communication. That is, in many serial network implementations, the commands and data consumption for the endpoints occurs on a device that is also a part of the serial network.

As noted above, the amount of data generated by network edge devices, specifically from connected passenger and commercial vehicles, and its collection by data consumers, such as cloud and data centers, is significantly increasing. For example, it can be assumed that there will be future requirements to stream data (telemetry) in real-time representing different data points in a vehicle from the CANBUS of the vehicle to answer particular questions in a cloud environment. However, the capabilities of existing communication infrastructures present a real limit on this data transfer and this data transfer limitation is expected to persist for many years to come.

At least on the surface, data compression would seem to be the natural approach to address the limited bandwidth of the communication infrastructure. However, doing so also typically entails distorting the data in some manner. Data should never be tampered with and should be left alone. Data is what was observed and cannot be changed after the event.

Vehicle Telematics with Super Resolution

According to various aspects of the techniques herein, it is possible to construct physical and behavioral models of the underlying physics of a system that “best” predict the observed data. In the particular case of vehicles, these models can be used to project new, synthetic data points at an even higher resolution and fidelity than that of the observed data points from the CANBUS or other sensors. In various aspects, these models reflect the states of the vehicle system as variables which could correspond at least to the underlying data, and exceed the measured points and even derive estimates for those not measured. The derivations are purely computed from the physical models and, thus, rely on how the physical characteristics of the vehicle are related. By way of simple example, the acceleration of the vehicle can be modeled and derived from other sensor inputs, even though few vehicles are actually equipped accelerometers.

Illustratively, the techniques described herein may be performed by hardware, software, and/or firmware, such as in accordance with the vehicle super resolution process 248, which may include computer executable instructions executed by the processor 220 (or independent processor of interfaces 210) to perform functions relating to the techniques described herein.

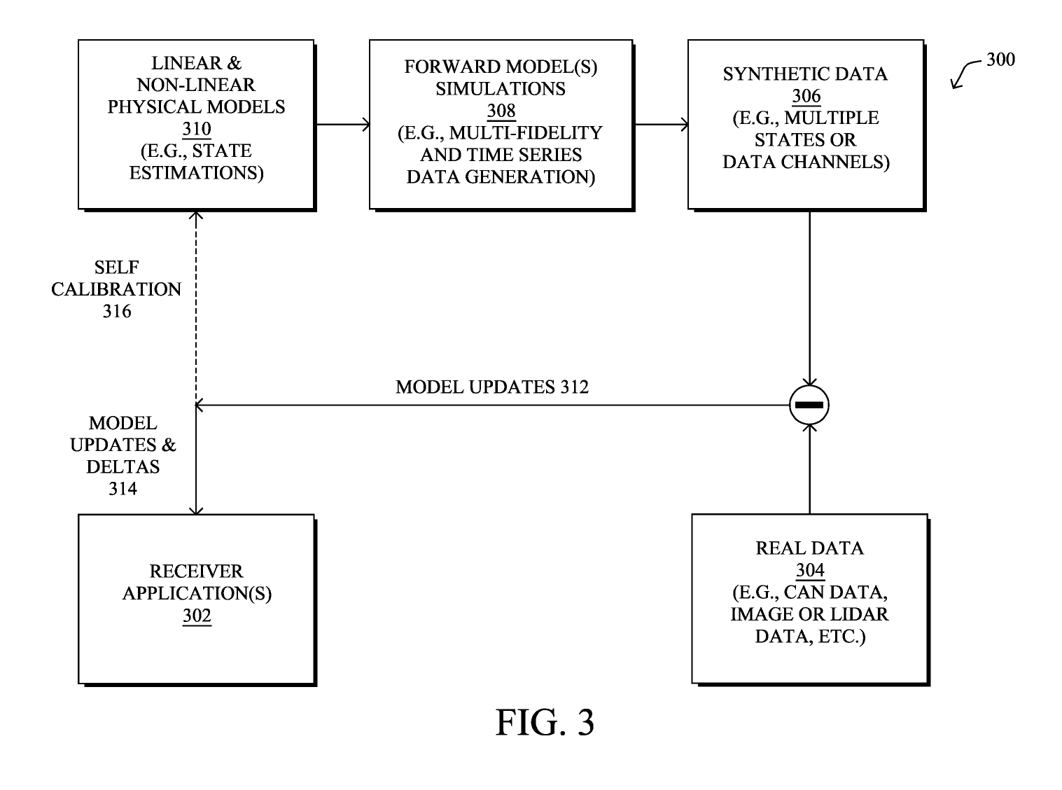

FIG. 3 illustrates an example architecture 300 for vehicle telematics with super resolution, according to various embodiments. As shown, assume that there are one or more receiver applications 302 that use as input data indicative of the physical characteristics of the vehicle. In various embodiments, the receiver application(s) 302 may be local to the vehicle itself (e.g., vehicle 102 shown in FIG. 1B) or, alternatively, at a remote location, such as a server 140, end device 142, or cloud-based application 144.

With respect to the physical characteristics of the vehicle, the vehicle itself may include any number of interconnected sub-systems that comprise any number of sensors. Notably, the vehicle itself may include any number of CAN buses or other sub-systems that provide the sensor data to a microcontroller or other processing circuit local to the vehicle. Accordingly, these sensors and sub-systems may provide real data 304 that is indicative of the physical characteristics of the vehicle. For example, real data 304 may include CANBUS data, image data, Lidar data, or the like, that comprises actual measurement values of the physical characteristics of the vehicle.

As would be appreciated, the collection of these measurements, as well as their reporting via their respective subsystems, may also vary from a temporal standpoint. For example, the update frequency of a GPS system may be quite different than that of an odometer reading from a CANBUS sub-system of the vehicle. In addition, because of the potential limitations of the communication infrastructure in conveying real data 304 to receiver application(s) 302, it may not be possible to send real data 304 to application(s) 302 for use in real-time or at the input rate needed by application(s) 302.

As shown, there may be linear and/or non-linear physical models 306 that describe the relationships between the physical characteristics of the vehicle. These models may, for example, allow for the computation of state estimations of the vehicle and determine conditions of the vehicle that are not directly measured by real data 304. For example, in the case of acceleration, this physical characteristic of the vehicle may be a function of the velocity and traveled distance of the vehicle over time. Such models 306 may be known or assumed, depending on the characteristics involve.

According to various embodiments, architecture 300 may perform any number of simulations 308 using forward model(s) that are based on the underlying physical models 306. For example, these simulations 308 may use multi-fidelity and time series data generation to generate synthetic data 310 (e.g., multiple states, data channels, etc.). Generally speaking, synthetic data 310 may include predicted states/characteristics of the vehicle that were not measured directly by the sub-systems of the vehicle, but were instead inferred based on the actual sensor measurements and on the prior state(s) of the vehicle.

In many embodiments, architecture 300 may leverage machine learning for the forward model(s) of simulations 308, so as to make better state predictions about the vehicle. In general, machine learning is concerned with the design and the development of techniques that receive empirical data as input (e.g., real telemetry data from the vehicle) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, the model M can be used to classify new data points, such as information regarding new traffic flows in the network. Often, M is a statistical model, and the cost function is inversely proportional to the likelihood of M, given the input data.

Example machine learning techniques that can be used to perform simulations 308 may include, but are not limited to, nearest neighbor (NN) techniques (e.g., k-NN models, replicator NN models, etc.), statistical techniques (e.g., Bayesian networks, Kalman filtering, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

In summary, the assumption made in architecture 300 is that, given the physical and behavioral models 306, architecture 300 can probabilistically predict what would be observed (the expected data), as well as what is not actually observed, through the underlying models and the measured data, to uphold the boundary conditions of the computational models. In turn, the resulting synthetic data 310 can be provided to receiver application(s) 302.

During operation, architecture 300 may compare the synthetic data 310 computed by simulations 308 to the real data 304 actually observed by the vehicle, to produce model updates 312. For example, architecture 300 may determine that a delta exists between the predicted state of the vehicle by simulations 308 and what is indicated by real data 304 from the sub-system(s) of the vehicle. In turn, these model updates and deltas 314 may be provided to receiver application(s) 302 and can also be used as self-calibration data 316, to recalibrate the models used to generate synthetic data 310.

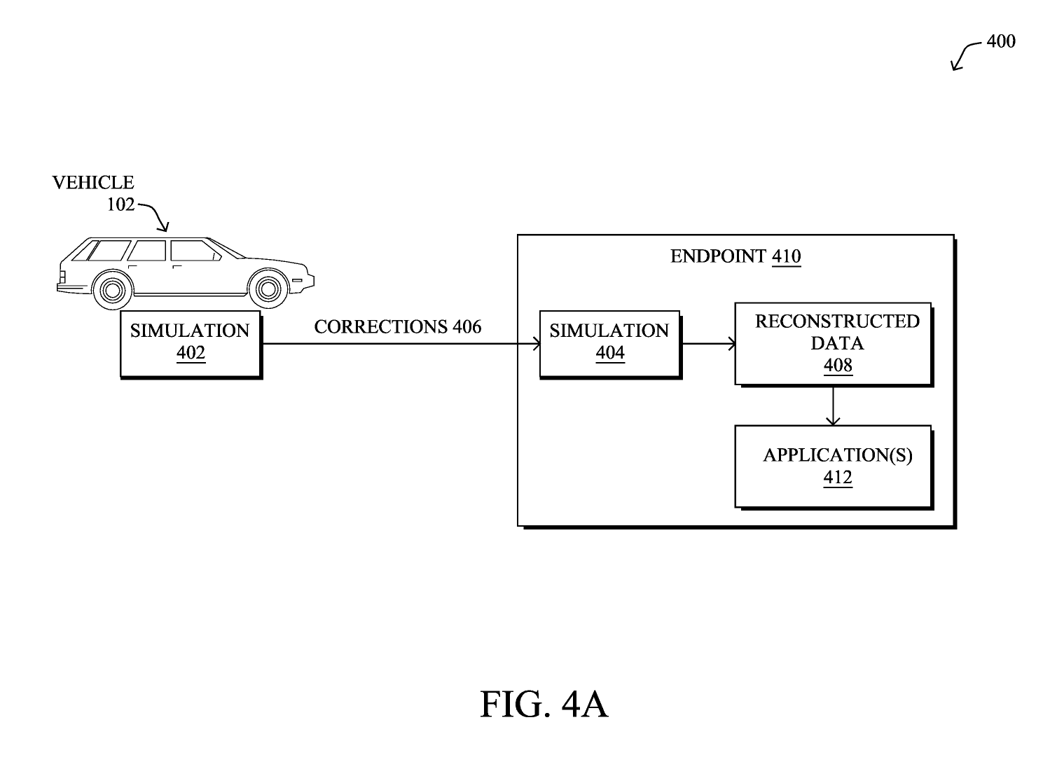

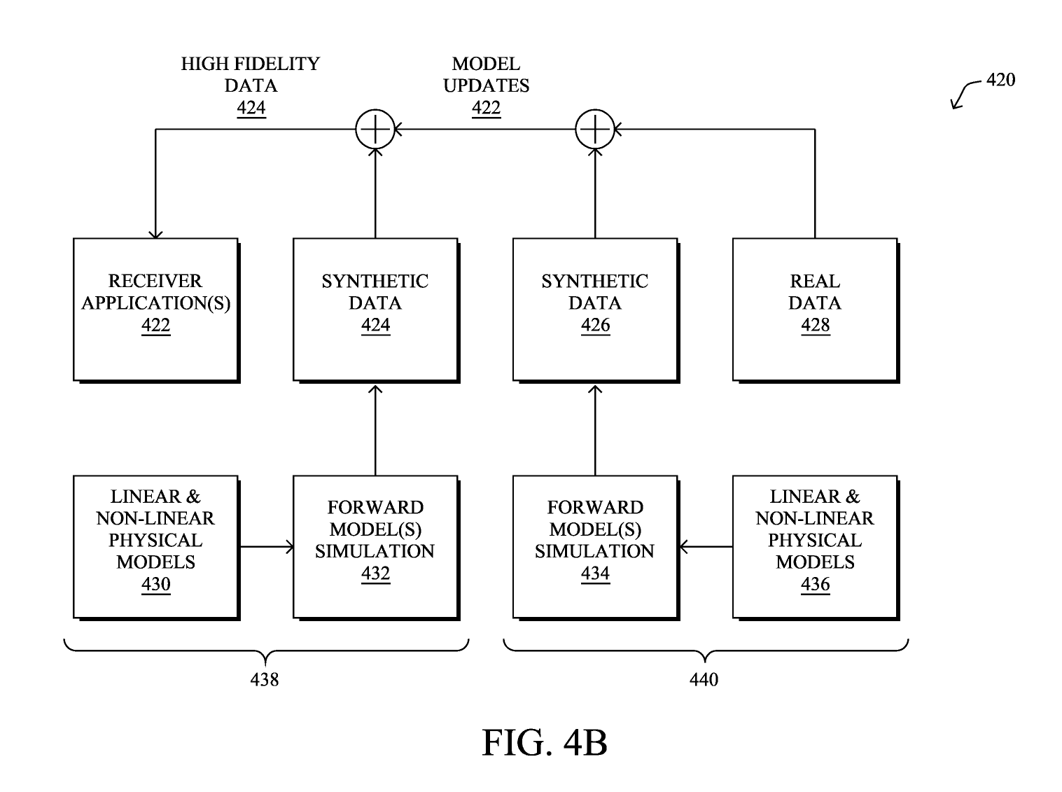

FIGS. 4A-4B illustrate an example of a vehicle providing data to a receiver application, according to various embodiments. As shown in FIG. 4A, in the particular cases of vehicle to vehicle (V2V) or vehicle to infrastructure (V2I) communications, vehicle 102 may send data to an endpoint 410 (e.g., a server, cloud service, end device, etc.). In such a case, network “compression” may be achieved by performing two simultaneous simulations of the vehicle: a local simulation 402 on-board vehicle 102 and a separate simulation 404 on endpoint 410 that output reconstructed data 408 for consumption by the receiver application(s) 412. When vehicle 102 detects deltas between the state predictions of its simulation 402 and the real data from its sub-systems, vehicle 102 may send the appropriate corrections 406 to simulation 404.

Very high network compressability is reached when the synthetic/reconstructed data 408 computed by simulation 404 produces good estimates from the models. The same difference is also computed and tracked in vehicle 102 validating that the errors are within the tolerance limits. In practice, the tolerance limit follows the noise tolerance of the sensors of vehicle 102 generating the real data. Adjustments are then reported to the cloud on an as-needed basis via corrections 406.

The assumption is considered that compressability using this technique will remove only noise (data lost) from the actual data. This is the differentiation when compared to other compression techniques. The benefits to this approach are three folds:
Continuous streaming
High compression ratio
Low noise to signal ratio

Further advantages are found with this approach in how to resolve conflicting data points coming from independent data points in the in-vehicle system. For example, a known conflict is found between the vehicle speed/odometer as the measurements from the CANBUS subsystem will conflict with the Global Position Systems (GPS) data measurements, begin another subsystem. In fact, GPS applications derive speed and distances in a global sense, which are computed from estimates of the longitudes, latitudes, and elevations associated with the vehicle. In contrast, the vehicle speed and odometer measurements are local to the vehicle, calculated from the revolutions per minute (RPM) of the wheels of the vehicle.

Architecture 420 in FIG. 4B further illustrates the concepts of FIG. 4A, in various embodiments. As shown, assume that there exists one or more receiver applications 422 that take as input data indicative of the physical states of a vehicle or other monitored system. Such a vehicle or other system may capture real data 428 regarding at least some of these characteristics (e.g., via sensors ,etc.). Instead of providing real data 428 directly to receiver application(s) 422, forward model simulations 434 that are based on the underlying linear and non-linear physical models 436 may be used to produce synthetic data 426. Thus, in the example shown, architecture 420 may include a sender 440 that captures real data 428 and generates synthetic data 426, as well as a receiver 438 that includes the receiver application(s) 422 that are to leverage this data. In some embodiments, receiver 438 may be remote from that of sender 440, such as external to the vehicle itself. However, further embodiments also provide for sender 440 and receiver 438 to both be located on-board the vehicle.

During operation, receiver 438 may itself mimic the forward simulations 434 of sender 440 using its own forward model simulation 432 and based on the underlying linear and/or non-linear physical models 430 for the vehicle. This allows the receiver 438 to output synthetic data 424 for use by application(s) 422. Model updates 422 provided by sender 440 may be used to adjust the operations/predictions of receiver 438, when sender 440 detects differences between real data 428 and synthetic data 426. This allows receiver 428 to effectively reconstruct the vehicle states from model updates 422 directly. As a result, receiver application(s) 422 may receive as input the resulting high is fidelity data 424.

In other words, the models used in architecture 420 perform the central thinking role for all of the real information in the data. These models are constructed from the prior knowledge of the physical processes and how physical dynamics interacts with their environment. Furthermore, vehicles are also designed and built from physics models. This central model could loosely be described as the system that “models” data, but it is not itself “data” or a “data product.”

To achieve the highest reliability with given measurements, the simulations may employ Bayesian probabilistic estimation, to allow robust statistical estimation of the most probable simulations, in various embodiments. Additionally, the uncertainty associated with the simulations can also be calculated. In particular, if the simulation uncertainty is high, it means that there is insufficient data/prior knowledge to accurately use the required model.

Another assumption that can be made is that the vehicle sensors are truly physical and, consequently, follow Gaussian probability distribution functions. The Bayesian approach then becomes an exercise of statistical computation of updating and tracking the means, variances and covariances. The Bayesian model-based data integration, outlined above (e.g., a dynamic and extended Kalman filter), in principle allows the system to integrate real measurements from multiple sub-system sources, which may be CAN-based or not. In addition, the proposed system can consume any modeled measurement at any frame update speed. There are many practical uses in merging computationally efficient different data points, especially in view of the huge amounts of data involved.

In other words, the approach introduced herein allows CAN data and other external data to be integrated into higher resolution data through the use of physical and behavioral models. The updated data is used by a compression application to determine whether data should be sent over the network. For example, odometers data and GPS data can be combined into higher fidelity estimates, using the super resolution techniques introduced herein. In such a case, the correlation between GPS and odometer data may be leveraged to eliminate redundancy in transmitting data over the network. All data can then be recreated, once received in the cloud or other receiver. In other words, the combination of different forms of sensor measurements (e.g., GPS, speed, odometer, tire pressure, etc.) can lead to higher data fidelity and time resolution than that of any particular form of sensor data alone.

In most commercial vehicles, model-based simulations (synthetic data) can be achieved today as an embedded, compute-enabled product. It can possibly be implemented, for example, deep within an in-vehicle network (IVN) engine control unit (ECU) in listening mode and as an end point to existing environment (e.g., by connecting CANBUS to other telemetry streams).

One can also assume that the measured data is continuously evaluated against the models and that noise estimation is made at a very high fidelity. Due to diversity of original equipment manufacturer (OEM) components in the automotive industry, different models can be used to retain quality and reflect different vehicle components and their relevant behaviors.

When more sensors and their resulting data points are translated through their underlying physics and behavioral laws to the high-resolution models, high-resolution data is consequently produced with optimal statistical definition. Simply put, the super resolution techniques provide a trade-analysis between the highly correlated data statistical threshold against multi-dimensional interpolation and extrapolation through the underlying physical and behavioral models.

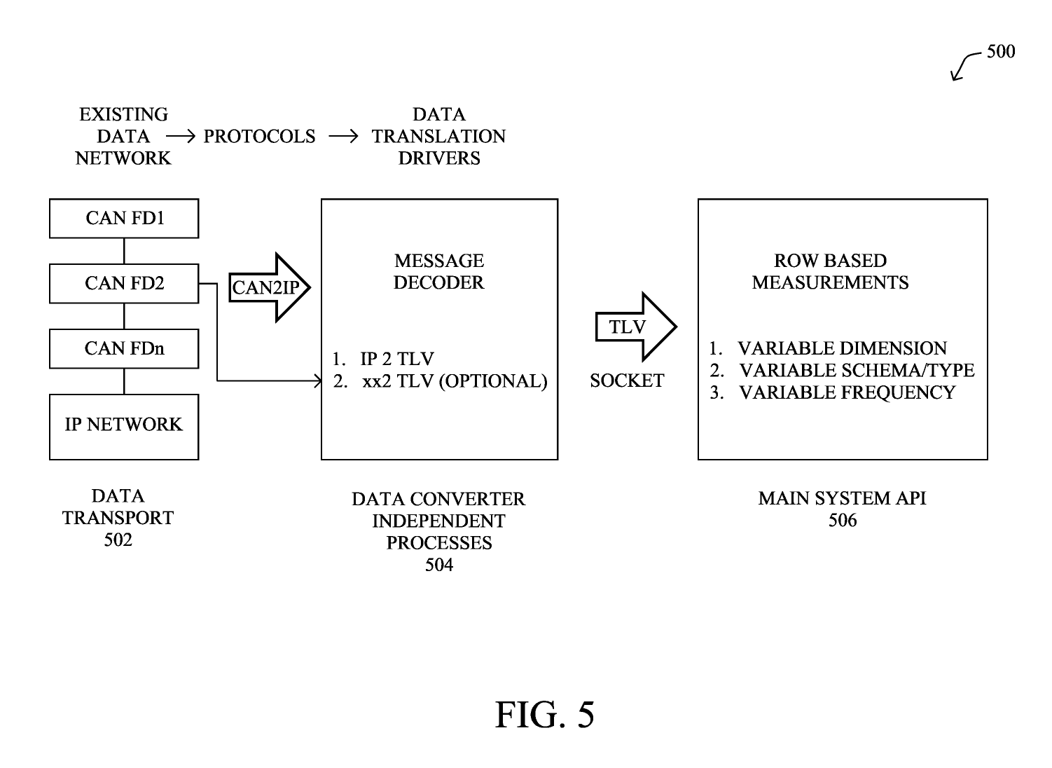

FIG. 5 illustrates an example 500 of data conversion in a vehicle, in various embodiments. From a data input standpoint, the super resolution system may be designed to be independent from the underlying I/0, for portability purposes, as well resource distributions in the environment. Accordingly, in some embodiments, software drivers may be used to convert the data into the system, independently. The three main criteria that dominate the data flow are the following:
1. Multiple data input
2. Asynchronous time of arrival of data
3. Variable count of measurements (at anytime)

As shown, consider the case of a vehicle that is equipped with a data transport 502 that comprises multiple CAN Flexible Data-Rate (FD) sub-systems running at potentially different clock rates (e.g., a first through n^{th} CAN FD sub-system). In such a case, one CANBUS may produce measurements at a faster rate than that of another CANBUS. Faster CAN FD sub-systems are intended for modern vehicles that require higher CANBUS speeds. Indeed, many modern vehicles have at least two isolated CANBUS sub-systems. Typically, power train sensors are grouped and isolated on a faster sub-system network than the rest. As shown, the data transport 502 may also include other forms of networks, in some embodiments. For example, certain vehicles may also include one or more IP networks, such as to facilitate V2V or V2I communications and/or as a separate sub-system within the vehicle itself.

In general, the proposed system should asynchronously process the data at the rate at which it is detected. Accordingly, the vehicle may include data converter and independent processes 504 that handle the data from the existing data transport layer 502. For example, one such data conversion may multiplex the input data at the record input level to preserve the sequence of measurements sequences as well as the time they have been made. Furthermore, the system will recognize other known systems that produce additional measurements. For example, a GPS sub-system may be connected to an entertainment gateway over an IP network in data transport layer 502. In that case, the data produced from the GPS can be made available to the system.

To manage diverse data inputs with different time resolution and formats from data transport 502, the data converter 504 may abstract the data into variable Type-Length-Value (TLV) format and prepare it as input to the main super resolution system as APIs 506. For example, as shown, the input to the super resolution system may be a row of measurements where the columns are the sensors types. Furthermore, with different input streams, the types will vary from a row to row. Consideration is also taken that a row of measurement represents a collection of measurements taken at a specific time. In other words, a row may include an additional data type which reflects time or is the timestamp of that moment. The timestamp may be derived from the sensor readings, most cases. The system may then internally compute the time difference between two consecutive rows of measurements.

In addition to the drivers of data converter 504 converting the data formats from data transport 502 into a TLV format that defines the API as input to the system, the drivers may also decode the data representation found in the underlying protocol. This is typical in a CAN message: a driver in that case will decode a CAN message ID into a pair value (name, value) where the name is the type identification understood by the system. The drivers are mappings table that converts the OEM ID to the System data types. The value component is a 32/64 bits precision based on the software build options having the underlying hardware platform as a typical target.

In various embodiments, the underlying protocol may be a CAN2IP protocol whereby a single IP packet contains one or more CAN messages. The driver in that case will decode the CAN messages and encapsulate one or many into a row of TLVs. It is clear that the number of entries in a row will vary, with a minimum one measurement and up to the complete sensors arrays. The row containing a timestamp is optional. With the option of a lack of timestamp signature, the system will behave in a deterministic way and use a new timestamp inherited from the clock from the underlying hardware.

Behavioral Models for Vehicles

As noted above, data integration is not an easy task when it needs to be accomplished in an efficient, cheap, real-time, and comprehensive manner. Furthermore, data integration is worthless if the underlying data is unreliable. Data is as reliable as the underlying the sensing models. For example, a slight variance in the tire size can put an odometer off by hundreds of miles from its true value, even over a short period of time. For the modern and future transportation vehicles, sensing is the most essential component in such an endeavor. Understanding the data nowadays overcomes the mere necessity of data collection and data transportation. In other words, a critical task is to understand the data itself before decisions are made from the data.

Behavioral modeling in a vehicle can be better understood with the GPS analogy. In GPS systems, the underlying GPS data comprises time echoes from satellites within sight. Collecting time records alone is worthless. However, extracting longitude, latitude, and elevation as state estimates renders the GPS system workable to locate and track the position of a vehicle. The underlying technology for a GPS system is the Doppler Differential Kalman Filter.

The techniques herein introduce methodologies for modeling the underlying physics of a vehicle, so as to best predict the observed data. From such physical models, it is possible to project new derived data points at a higher resolution and fidelity, which appears as a set of state variables for the vehicle. In some aspects, this set is a union of state variables that are measured and those that are purely derived from physical and behavioral models. That is, given the model, the behavioral modeling techniques herein can probabilistically predict what would be observed (the expected data) and the non-observed through the underlying models.

Specifically, according to one or more embodiments of the disclosure as described in detail below, a processor of a vehicle receives a plurality of variables indicative of physical characteristics of the vehicle. The processor uses a machine learning-based model to predict physical states of the vehicle from the plurality of variables indicative of physical characteristics of the vehicle. The model predicts a current physical state of the vehicle from at least two or more prior physical states of the vehicle, and is based on a physical relationship between the physical characteristics. The processor sends synthetic data indicative of the predicted current physical state of the vehicle for use by a receiver application. The processor provides an update to the receiver based on a comparison between the predicted current physical state of the vehicle and the plurality of received variables.

Operationally, as noted, a vehicle may comprise multiple sub-systems, such as GPS, tire, fuel, engine, vehicle dynamics, and the like. Each of these sub-systems may be represented by a set of state variables. In turn, physical and behavioral models for these sub-systems can be developed to predict the behavior of the sub-systems over time. Such a model may, for example, predict the current state based on the n-th order derivative of previous states. In particular, the physical states may be modeled and represented as a state numerical vector in a vector matrix format for the said variables with dimension representing the states of interests.

In various embodiments, the state vector may be inserted in an enhanced dynamical, system recursion model that takes the following general format whereby ‘0^{th}’, represents the current state, ‘1^{th} ’ represents the previous state, etc.:

[x0]=[A1].[x1]+[A2].[x2]+ . . . +[An][xn]+[B][u] (equation 1)

where [x0] is the current state, {[x], [x2], . . . [xn]} are the previous ‘n’ states, and {[A1], [A2] . . . [An]} are the prediction step matrices for each derivative.

An approximation and practical implementation of this modeling is to increase the use of the dynamical system representation beyond the previous state only. These models can reflect better the non-linearity inherently part of the underlying physical subsystems. In addition, there can be external influences that affect the prediction. This is represented in the above question by corresponding control state vector [u] and control matrix [B], respectively.

By way of explicit example, consider a vehicle dynamics sub-system. In this sub-system, there may be four state variables: time (t), velocity (v), acceleration (a), and distance/displacement (d), that describe the dynamics of the vehicle. Note that not all of these physical characteristics may be measured directly in the vehicle. For example, it may very well be that the vehicle itself is not equipped with an accelerometer that directly measures the acceleration of the vehicle. Underlying these state variables may be a physical model that describes the physical relationships between these characteristics. Notably, these characteristics may be related according to the following physical dynamics equation:

d=1/2 at²+vt (equation 2)

To build a behavioral model from this physical model, a state vector can be constructed as follows:

xᵢ=[t v a d ]T (equation 3)
Using this state vector in equation 1 above and based on the physical relationship between the characteristics, first and second order state matrices, A₀ and A₁, respectively, can be constructed as follows:

$$\begin{matrix}{A}_{1} = [ \begin{matrix}1 & 0 & 0 & 0 \\ 0 & α & dt & 0 \\ 0 & \frac{1}{dt} & 0 & 0 \\ 0 & dt & \frac{1}{2} {dt}^{2} & α\end{matrix} ] & ( equation 4 ) \\ {A}_{2} = [ \begin{matrix}0 & 0 & 0 & 0 \\ 0 & ( 1 - α ) & 0 & 0 \\ 0 & - \frac{1}{dt} & 0 & 0 \\ 0 & 0 & 0 & ( 1 - α )\end{matrix} ] & ( equation 5 )\end{matrix}$$

where the proportionality (∝) is an arbitrary number and the time differential (dt) is the time resolution between two states. The two state matrices, A₀ and A₁, are modeled in this sub-system to reflect the differential aspect of the quadratic nature of the dynamic physical equation 2 above. The system models the differential state for both matrices, evaluating the acceleration instantaneously rather than depending on the acceleration variable reflected in the state vector.

In the absence of an explicit model, according to various embodiments, the default super resolution system will approximate a generic linear model. Such approximations will reduce the correlation factors. The approximate takes on a differential equation model, computing dx/dt from the state matrices or as a pair variable:

[x₀]=[1/dt 0; dt 1].[x₁]+[−1/dt 0; 0 0].[x₂] (equation 6)

where the first variable computes the derivative and the second compute the estimation over a period dt.

In contrast to standard linear systems, the above approach also allows for the effective modeling of non-linear systems. In particular, standard models are linear and rely on the previous state, which is a linear interpolation limitation. However, by increasing the differentiability of the state equation to two or more prior states (e.g., by modeling two or more previous states), this leads to a higher fidelity in the interpolation and the extrapolation of the inherent non-linearity of the sub-systems.

While considering additional prior states in the model will improve the fidelity of the prediction, it will not make it non-linear. For example, the model X₀=X₁+X₂+X₃ is still linear and cannot be referred to as non-linear. In contrast, a non-linear system is possible by just having one prior state such as X₀=X₁²+X₁+2. By increasing the prior states, the evaluation of a non-linear system reflects the correct time rather than having to have lag in the state. Lag of a state is defined as the number of historical data used in the prediction. Therefore, more states imply more lag. However, the opposite is actually true.

In some embodiments, the above techniques can be extended to non-linear systems with higher order, non-linear complexity by using an expansion method, such as the Euler expansion method. Using such a method, an exponential model can be broken down into a quadratic representation. If a model is represented by a non-linear function that is differentiable, then such functions can be represented as Taylor series or likewise, so that a linear approximation of the non-liner model can be achieved. This can be solved using extended Kalman filtering techniques, in some embodiments. However, Euler expansion results in representing an exponential as a complex quadratic equation and not a quadratic one.

Further, any linear transformations, such as Fourier transforms or inverse Fourier transforms, can be performed inline as state calculations where the state matrix model is integrated over the time series states. An example of this would be the RPM of the engine where the underlying time series data is the angle of axial rotations from a reference point. Another example of this would be the inertia sensor (acceleration) of the vehicle where the underlying time series data is the vehicle inertia of the vehicle in three dimensions from a reference point. Extending this where the limited window for such transformations are performed with specific integral state matrix models whereas these integrals are performed over time series, the oldest transformed vector can be subtracted directly (differential) from the already transformed states.

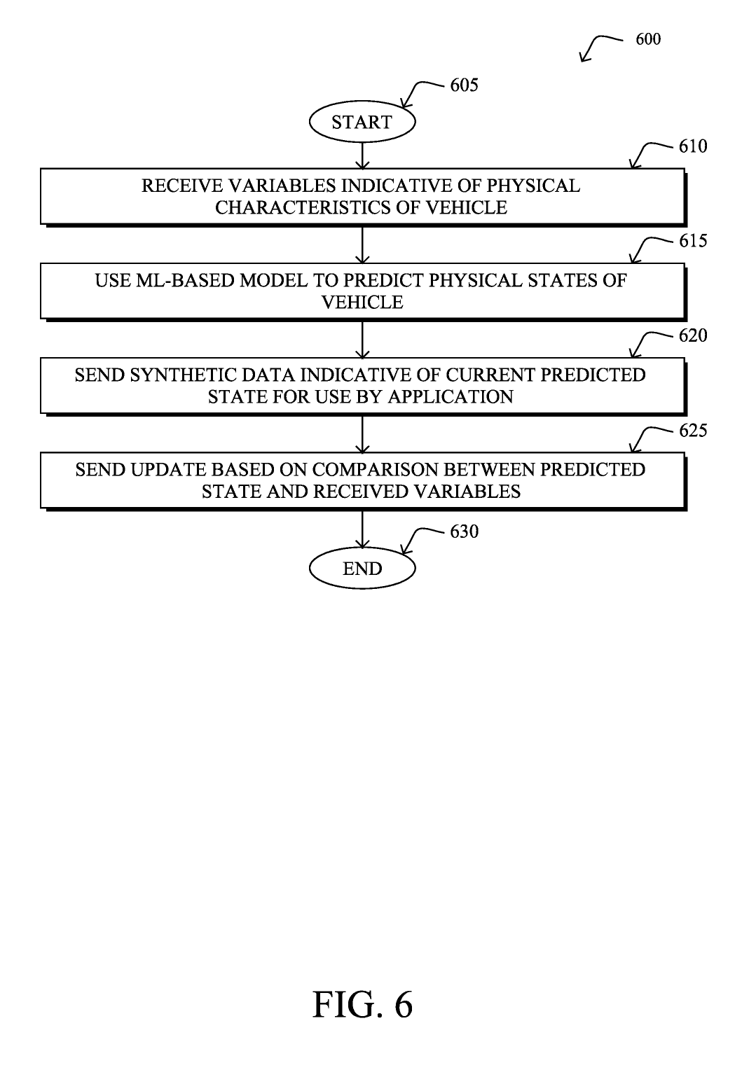

FIG. 6 illustrates an example simplified procedure for modeling vehicle behavior, in accordance with one or more embodiments described herein. For example, the processor of a non-generic, specifically configured device (e.g., device 200) may perform procedure 600 by executing stored instructions (e.g., process 248). The procedure 600 may start at step 605, and continues to step 610, where, as described in greater detail above, the processor may receive a plurality of variables indicative of physical characteristics of the vehicle. For example, the processor may receive sensor measurements from one or more sub-systems of a vehicle, such as CAN buses, IP networks, or the like.

At step 615, as detailed above, the processor may use a machine learning-based model to predict physical states of the vehicle from the plurality of variables indicative of physical characteristics of the vehicle. In various embodiments, the model predicts a current physical state of the vehicle from at least two or more prior physical states of the vehicle. In further embodiments, the model may be based on a physical relationship between the physical characteristics of the vehicle. For example, in the case of vehicle dynamics, the prediction model may be based on the physical relationships between time, distance/displacement, velocity, and acceleration of the vehicle. In another example, GPS sub-system variables may include longitude, latitude, elevation, and/or distance.

At step 620, the processor may send synthetic data indicative of the predicted current physical state of the vehicle for use by a receiver application, as described in greater detail above. In some embodiments, the receiver application may be local to the vehicle. In further embodiments, the processor may send the synthetic data for consumption by an application hosted by a device external to the vehicle, such as a cloud-based application, or the like.

At step 625, as detailed above, the processor may also send an update to the receiver based on a comparison between the predicted current physical state of the vehicle and the plurality of received variables. For example, if the current state prediction varies from that indicated by the real data collected from the sub-system(s) of the vehicle, the processor may send a model update. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for a vehicle or other monitored system to send high fidelity telemetry data for consumption by an application, in a manner that greatly reduces the overhead on the communication infrastructure. In particular, behavioral models can be used to perform simulations and generate synthetic data which can be used in lieu of streaming the actual sensor data in real-time.

While there have been shown and described illustrative embodiments that provide for behavioral models for vehicles, it is to be understood that various other adaptations and modifications may be made within the spirit and scope of the embodiments herein. For example, while the techniques herein are described primarily with respect to vehicles that include one or more CANBUS sub-systems, the techniques herein can also be adapted for use in manufacturing where the underlying protocol is MODBUS. In MODBUS, the underlying sensors reflect manufacturing processes, robotics, and other sensory and actuating found in the energy sector.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a processor of a vehicle, a plurality of variables indicative of physical characteristics of the vehicle;
using, by the processor, a machine learning-based model to predict physical states of the vehicle from the plurality of variables indicative of physical characteristics of the vehicle, wherein the model predicts a current physical state of the vehicle from at least two or more prior physical states of the vehicle, and wherein the model is based on a physical relationship between the physical characteristics;
sending, by the processor, synthetic data indicative of the predicted current physical state of the vehicle for use by a receiver application; and
providing, by the processor, an update to the receiver based on a comparison between the predicted current physical state of the vehicle and the plurality of received variables.

2. The method as in claim 1, wherein the processor receives the plurality of variables from a Controller Area Network (CAN) bus of the vehicle.

3. The method as in claim 1, wherein sending the data indicative of the predicted current physical state of the vehicle for use by the receiver application comprises:
wireles sly transmitting the synthetic data from the vehicle for delivery to the receiver.

4. The method as in claim 1, wherein the physical relationship between the physical characteristics is a non-linear relationship, and wherein the machine learning-based model uses a linear approximation of the non-linear relationship to predict the current physical state of the vehicle.

5. The method as in claim 1, wherein the machine learning-based model represents the physical states as state matrices of the physical characteristics.

6. The method as in claim 5, wherein the machine learning-based model further comprises a control state vector and control matrix to account for external influences that may affect predictions by the model.

7. The method as in claim 1, wherein the physical characteristics comprise at least one of: velocity, acceleration, time, or distance.

8. The method as in claim 1, wherein the physical characteristics comprise at least one of: longitude, latitude, or elevation.

9. The method as in claim 1, wherein the receiver application is executed locally by the vehicle.

10. An apparatus, comprising:
one or more network interfaces to communicate with a network;
a processor coupled to the network interfaces and configured to execute one or more processes; and
a memory configured to store a process executable by the processor, the process when executed configured to:
receive a plurality of variables indicative of physical characteristics of a vehicle;
use a machine learning-based model to predict physical states of the vehicle from the plurality of variables indicative of physical characteristics of the vehicle, wherein the model predicts a current physical state of the vehicle from at least two or more prior physical states of the vehicle, and wherein the model is based on a physical relationship between the physical characteristics;
send synthetic data indicative of the predicted current physical state of the vehicle for use by a receiver application; and
provide an update to the receiver based on a comparison between the predicted current physical state of the vehicle and the plurality of received variables.

11. The apparatus as in claim 10, wherein the processor receives the plurality of variables from a Controller Area Network (CAN) bus of the vehicle.

12. The apparatus as in claim 10, wherein the apparatus sends the data indicative of the predicted current physical state of the vehicle for use by the receiver application by:
wireles sly transmitting the synthetic data from the vehicle for delivery to the receiver.

13. The apparatus as in claim 10, wherein the physical relationship between the physical characteristics is a non-linear relationship, and wherein the machine learning-based model uses a linear approximation of the non-linear relationship to predict the current physical state of the vehicle.

14. The apparatus as in claim 10, wherein the machine learning-based model represents the physical states as state matrices of the physical characteristics.

15. The apparatus as in claim 14, wherein the machine learning-based model further comprises a control state vector and control matrix to account for external influences that may affect predictions by the model.

16. The apparatus as in claim 10, wherein the physical characteristics comprise at least one of: velocity, acceleration, time, or distance.

17. The apparatus as in claim 10, wherein the physical characteristics comprise at least one of: longitude, latitude, or elevation.

18. The apparatus as in claim 10, wherein the receiver application is executed locally by the vehicle.

19. A tangible, non-transitory, computer-readable medium storing program instructions that cause a processor in a vehicle to execute a process comprising:
receiving, at the processor of the vehicle, a plurality of variables indicative of physical characteristics of the vehicle;
using, by the processor, a machine learning-based model to predict physical states of the vehicle from the plurality of variables indicative of physical characteristics of the vehicle, wherein the model predicts a current physical state of the vehicle from at least two or more prior physical states of the vehicle, and wherein the model is based on a physical relationship between the physical characteristics;
sending, by the processor, synthetic data indicative of the predicted current physical state of the vehicle for use by a receiver application; and
providing, by the processor, an update to the receiver based on a comparison between the predicted current physical state of the vehicle and the plurality of received variables.

20. The computer-readable medium as in claim 19, wherein the processor receives the plurality of variables from a Controller Area Network (CAN) bus of the vehicle.
